(19) United States
(12) Patent Application Publication
(10) Pub. No.: US 2026/0139904 A1
(43) Pub. Date: May 21, 2026

(54) Telescoping Ram and Methods for Its Use in Transferring Solid Material

(71) Applicant: GTI Energy, Des Plaines, IL (US)

(72) Inventor: Martin B. Linck, Wilmette, IL (US)

(21) Appl. No.: 19/393,227

(22) Filed: Nov. 18, 2025

Related U.S. Application Data
(60) Provisional application No. 63/721,932, filed on Nov. 18, 2024.

(51) Int. Cl. F27D 3/04; F27B 5/04; F27D 3/00

(52) U.S. Cl. CPC F27D 3/04; F27B 5/04; F27D 3/0033

(57) ABSTRACT

Telescoping rams, such as more particularly two-stage telescoping rams, are disclosed, having a primary ram and a secondary ram, with the secondary ram being at least partly disposed within the primary ram. The primary ram and secondary ram are configured for displacement, responsive to pressure applied in a primary pressure shell, and the secondary ram is configured for independent displacement with respect to the primary ram, responsive to pressure applied in a secondary pressure shell. Apparatuses comprising such telescoping rams are disclosed, as well as methods using such telescoping rams and associated apparatuses, for the transfer of solid particles.

### CROSS REFERENCE TO RELATED APPLICATION

This application claims the benefit of priority to U.S. Provisional Application No. 63/721,932, filed Nov. 18, 2024, which is hereby incorporated by reference in its entirety.

### FIELD OF THE INVENTION

Aspects of the invention relate to rams, such as multi-stage (e.g., two-stage) telescoping rams for transferring solid particles (e.g., biomass), from a first (e.g., ambient) environment to a second (e.g., pressurized) environment, such as an environment of a process (e.g., gasification, pyrolysis, or hydropyrolysis) having an elevated pressure and/or temperature that is suitable for transformation of the solid particles into higher value products such as synthesis gas.

### DESCRIPTION OF RELATED ART

Over the past 150 years, many devices, operating according to various mechanisms and implemented in a variety of systems, have been built and tested for the purpose of conveying granular or particulate feedstocks across a pressure boundary, and into a pressurized process environment. Very early devices of this type, used in the late 1800s, were loading locks installed at the tops of blast furnaces of steel mills. In the 1920s, the Winkler Gasifier implemented lock hoppers, with solids-tolerant valves at both ends and the ability to pressurize the internal atmosphere as feedstock was loaded. In the 1960s and 1970s, IGT (currently operating under the registered name of GTI Energy) participated in extensive trials, coordinated and funded by the U.S. Department of Energy, in the search for improved valves for coal gasification lock hoppers. In similar endeavors, global paper manufacturing has also long depended on systems such as plug screw feeders, for conveying large volumes of damp or steam-softened wood chips into processing vessels in the production process. With a new focus on renewable energy in the 1970s and 1980s, research on lock hoppers for transporting biomass feedstocks gained momentum. In addition, a number of other devices designed for this objective were built and tested, including those based on hybrid screw/pistons and “locked-up” plugs of feedstock, the latter of which approach is described in U.S. Pat. No. 6,213,289 by Stamet, Inc.

Currently, the only loading system available for use with pressurized conversion processes at industrial scale is based on lock hoppers, which transfer feedstocks in the form of dry, granular solids. Alternative systems, such as slurry pumps and plug screw feeders, are compatible only with materials that are quite “wet,” in the sense of having either a large amount of water or otherwise being lubricated by a liquid carrier medium. Attempts to implement so-called “dynamic” dry plug feeder systems, such as those based on rotors and dry solids pumps, have proven to be impractical and/or cost prohibitive, compared to lock hoppers. A comprehensive overview of known solid feedstock loading technologies is provided in a PhD Thesis of James M. Craven (“Energy Efficient Solids Feed System for High Pressure Processes” (2014) University of Sheffield). This paper documents the hindrances and failure mechanisms that have rendered most mechanisms, proposed for solids transport to pressurized environments, commercially non-viable. These difficulties with respect to practical implementation are also evidenced by the unavailability for purchase of systems for this purpose, with the exception of lock hoppers that include some performance warranties. Certain entities engaging more recently in piston and ram feeder development have proposed the use of multi-piston feeder systems.

To date, however, the art has not provided a satisfactory solution for solids delivery across a pressure barrier, with commercially-viable capital and operating costs, which are impacted by a number of characteristics including cycle rate, maintenance downtime, energy consumption, and compressed gas usage (e.g., purge gases or process gases). The importance of addressing this challenge is magnified by the fact that solids handling equipment can account for 10%-20% of the cost of a plant for carrying out gasification, pyrolysis, hydropyrolysis, and other carbonaceous material (e.g., biomass) conversion processes that are considered essential to the ongoing efforts in replacing fossil fuels with their renewable counterparts.

### SUMMARY OF THE INVENTION

Aspects of invention relate to apparatuses for conveying solids, which are distinguished in their ability to overcome disadvantages encountered in the art, including those noted above with respect to existing and proposed systems. The disclosed apparatuses namely provide a simple, mechanically robust, cost effective, and/or energy solution that has been diligently sought in this field of endeavor. The apparatuses are effective for the conveyance of solid particulate feedstocks to, for their subsequent conversion within, pressurized systems, and particularly those used in applications that have conventionally faced difficulties associated with their commercialization. For example, a key hurdle to economic feasibility included the high costs and complexity of lock hoppers, stemming in part from their significant energy and compressed gas requirements. Solids transfer apparatuses described herein are distinct both in terms of their structural features, and combinations of features, as well as in terms of the steps, and combinations of steps, involved in their operation, with such feature(s) and operating step(s) being characteristic of a telescoping ram. Exemplary rams are configured for, and operate by, moving solid feedstock first into a sealed equilibration chamber (e.g., defining an isolation zone), via action of a primary ram (e.g., in the case of movement of both primary and secondary rams together), and then into the process environment, via action of a telescoping, secondary ram that extends outwardly from the front end (or front face) of the primary ram.

The disclosed apparatuses pertain broadly to the field of transferring solids, including solid particles (e.g., grains, granules, fibers, shreds, pellets or other compacted masses, or other forms) from ambient conditions to a pressurized environment. In particular embodiments, solid particles being transferred are those of biomass, or comprise biomass. Biomass or other solid particles may have an average particle size (e.g., based on their longest dimension) in a range from about 10 μm to about 10 mm, from about 50 μm to about 5 mm, or from about 100 μm to about 3 mm. The biomass or other solid particles may be pre-sized to achieve these or other desired, average particle sizes, such as by shredding, grinding, milling, crushing, or comminuting generally. In addition, or alternatively, to adjusting the average particle size, the particle size distribution may be adjusted, such as by screening. Other pretreatments to modify particle size, particle uniformity, particle shape, and/or particle density may be implemented, such as by pelletization to provide compacted cylinders, spheres, or other forms. Biomass or other solid particles being transferred may have a moisture content of less than about 20 wt-%, less than about 10 wt-%, or less than about 5 wt-%. The biomass or other solid particles may be dried, such as by air drying or oven drying, to achieve these or other desired moisture levels. However, given the robustness and flexibility of the disclosed apparatuses, drying in some embodiments may not be required, such that the biomass or other solid particles may be transferred “as received,” or at least without pretreatment to adjust moisture content. For example, the moisture content may be greater than about 5 wt-% (e.g., from about 5 wt-% to about 30 wt-%) or greater than about 10 wt-% (e.g., from about 10 wt-% to about 30 wt-%), or possibly even greater than about 15 wt-% (e.g., from about 15 wt-% to about 30 wt-%). In some embodiments, the apparatus may be operated without pretreatment as described above to adjust particle physical properties, whether or not drying is used to reduce particle moisture content.

The process, into which the secondary ram extends for delivery of the solid particles, may have a pressurized environment, such as that used for producing one or more higher value products, with synthesis gas being an example. The synthesis gas, and therefore the process environment, may comprise H₂ and CO, such as in a combined amount of at least about 10 mol-%, at least about 25 mol-%, or at least about 50 mol-%. In other embodiments, the process environment may comprise one or more of H₂, CO, and/or CO₂, individually and independently in these amounts, or in these combined amounts with respect to any two, or all three, of these components. The environment may be that of a process (e.g., a biomass conversion process) in which air and/or oxygen are substantially excluded, and/or to which no air and/or oxygen is introduced. For example, in the process environment, and optionally in conjunction with one or more of H₂, CO, and/or CO₂ being present in amounts as described above, nitrogen and/or oxygen may be present individually and independently in amounts, or otherwise may be present in a combined amount, of less than about 1 mol-%, less than about 0.5 mol-%, or less than about 0.1 mol-%. The process environment may have a pressure, for example, from about 1 bar (14.5 psi) to about 100 bar (1450 psi), from about 10 bar (145 psi) to about 30 bar (435 psi), or from about 5 bar (72 psi) to about 20 bar (290 psi). Independently or in combination with such pressure, the process environment may have a temperature from about 100° C. (212° F.) to about 1200° C. (2192° F.), from about 300° C. (572° F.) to about 1000° C. (1832° F.), or from about 500° C. (932° F.) to about 800° C. (1472° F.).

The environment may be suitable for gasification, pyrolysis, or hydropyrolysis of biomass. With respect to gasification, the process environment may be more broadly suitable for partial oxidation of biomass. In other embodiments, the process environment may be suitable for the torrefaction of biomass. In particular embodiments, the process environment may be suitable for pyrolysis or torrefaction as an initial, first step that precedes an oxidative conversion, such as gasification, partial oxidation, or possibly the combustion, of the resulting pyrolysis vapors or torrefaction vapors. The process environments may otherwise be suitable for performing any of these transformations (e.g., gasification, pyrolysis, or hydropyrolysis) of non-biomass solids, such as coal, in the case of non-biomass solids being transferred with apparatuses described herein. In general, the disclosed apparatuses may be used for transferring biomass or non-biomass solids (e.g., as solid particles), or possibly transferring biomass that is mixed or consolidated with non-biomass solids, such as in the case of transferring municipal solid waste (MSW). In addition to coal, representative non-biomass solids, whether transferred alone or in conjunction with biomass (e.g., as a mixture or consolidated component), include plastics, metals, metal oxides (e.g., silica, such as in the form of sand), and glass.

In the operation of apparatuses described herein, displacement or extension of the primary ram, or, more particularly, the primary ram and secondary ram together, can be used to initially transfer solid particles from an ambient conditioning zone in a first environment. This zone may be fed or loaded through an opening, such as that of a solids transmission conduit. The opening may be formed by the primary and secondary rams being initially in an at least partially retracted position. In one embodiment, a loading hopper, such as being fed by a conveyor belt or other solids conveying medium, may be aligned with this opening, for feeding of the solid particles into this opening and thereby into the solids transmission conduit. Initial motion of the primary and secondary rams together may cause the transfer of the solid particles from the ambient conditioning zone into an isolation zone in an intermediate environment, which may subsequently be sealed within the solids transmission conduit. For example, a live seal may be activated to seal/isolate one end, such as a first end, of the isolation zone, opposite a second end that is sealed from the second environment of the process by a valve. Following activation of the live seal (e.g., at all times when the live seal remains active), the primary ram may be held stationary, such as in the case of being locked in position. The live seal may therefore be considered a “reversable” or “temporary” seal that is activated and maintained by pressurization of a live seal ring surrounding the primary ram, or conversely deactivated and removed by depressurization of this live seal ring. The live seal, operating in conjunction with the valve, may thereby serve to isolate the solid particles, in the isolation zone that is between (i) the primary ram (or both the primary and secondary rams) at the first end and (ii) the valve at the second end, from both the ambient conditioning zone and the second environment of the process.

With the primary ram (or both primary and secondary rams) being stationary and the live seal activated, subsequent displacement or extension of the secondary ram with respect to the primary ram may then cause the front end of the secondary ram to move through, and open, the valve and thereby “kick” the solid particles through this valve and into a second environment of the process. Retraction of the secondary ram, or front end thereof, with respect to the primary ram, back through the valve and in the opposite direction, may cause the valve to re-seat under influence of the pressure of the second environment (e.g., process pressure) and/or other (e.g., mechanical, such as spring) forces biasing the valve towards the closed position. The secondary ram, or front end thereof, may be further retracted through the isolation zone. Additional, subsequent retraction of the primary ram and secondary ram together, such as back through the ambient conditioning zone, may then again cause the opening to be formed in this zone, essentially resetting the apparatus in its starting state and allowing for a separate or discreet quantity of solid particles to be loaded into the ambient conditioning zone and transferred in the same manner.

The disclosed apparatuses and their operation can advantageously prevent solid particle “bridging,” by avoiding vessel-to-vessel transfer of feedstock volumes through valves, with in-between resting of the solids. Wear on valves seats is likewise mitigated, by the reduction in valve service severity that might otherwise be encountered with high contact pressures of valve components, such as those sliding across one another (e.g., in the case of a metal-seated ball valve). Usage of compressed gas is greatly reduced, due to the motion of the secondary ram, acting on the feedstock and surrounding gas, which in some cases is alone sufficient to raise pressure in the equilibration chamber above that of the process during feedstock ejection. Moreover, the capability of disclosed apparatuses to cycle as rapidly as the feedstock can be conditioned/equilibrated imparts yet further operational benefits. For example, in representative embodiments, a full cycle of the telescoping ram operation as described herein may be completed in less than about 60 seconds (e.g., from about 1 to about 60 seconds), less than about 30 seconds (e.g., from about 1 to about 30 seconds), or even less than about 15 seconds (e.g., from about 1 to about 15 seconds). A conventional lock hopper, in contrast, can cycle typically at a rate of 3-4 times per hour when operated at commercial scale. This allows, in the case of a telescoping ram as described herein, for very high volumetric capacity, together with reductions in energy consumption, operating cost, and compressed gas usage, to the extents physically realizable. These substantial improvements can translate to reductions in capital and/or operating costs (e.g., 5-10%, or possibly more) over baseline gasification, pyrolysis, or hydropyrolysis processes utilizing conventional solids-handling equipment.

These and other embodiments, aspects, and advantages relating to the present invention are apparent from the following Detailed Description.

### BRIEF DESCRIPTION OF THE DRAWING

An understanding of exemplary embodiments of the present invention and the advantages thereof may be acquired by referring to the following description in consideration of the accompanying figures, in which the same reference numbers throughout the figures are used to indicate the same or similar features.

FIGS. 1-6 illustrate telescoping rams and various associated features.

FIG. 7 illustrates an overhead (top-down) view of an apparatus for transferring solid particles.

FIGS. 8-16 illustrate side views of apparatuses for transferring solid particles and various features. These figures may be representative, in certain embodiments, of steps in methods for transferring solid particles. In particular embodiments, any two or more, or all, of these steps may be performed in the order of the figures.

FIG. 17 illustrates a side view of an apparatus utilizing optional, ambient conditioning zone purge gas.

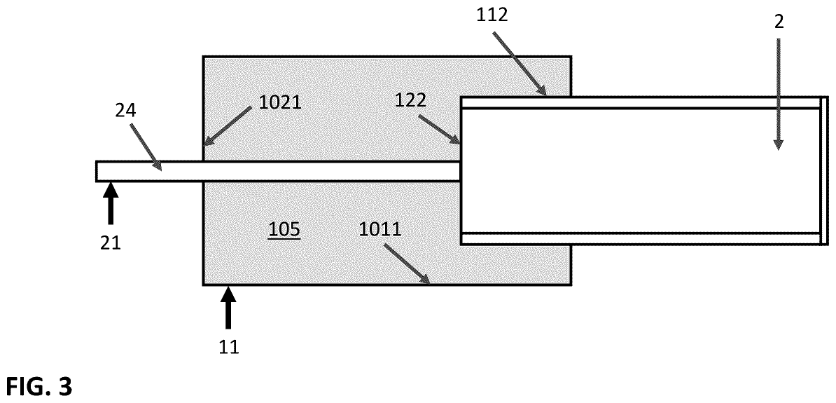

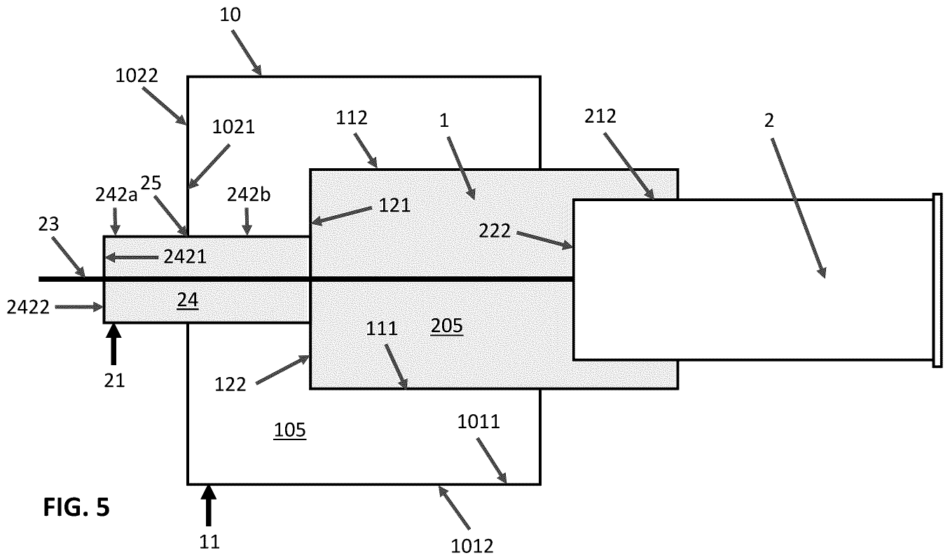

Whereas the figures illustrate multiple possible components and steps that may be implemented individually or in any combination, not all components and steps are required in, or essential to, the practice of certain inventive embodiments described herein. It should be understood that various specific components and steps can be respectively utilized and implemented independently of others. The figures are not necessarily drawn to scale, and in fact certain features may be exaggerated in some cases (e.g., in FIGS. 3 and 5) for ease of identifying some features. In order to facilitate explanation and understanding, the figures provide overviews of telescoping rams, apparatuses comprising these rams, and methods utilizing these rams/apparatuses for the transfer of solid particles. Some associated equipment and/or procedures may be omitted in the case of the specific description of such equipment and/or procedures not being essential with respect to the practice of various inventive embodiments, as those details would be apparent to those having skill in the art, with the knowledge gained from the present disclosure. Other apparatuses and methods, according to other embodiments within the scope of the invention and having components and steps determined, in part, according to particular objectives, would likewise be apparent.

### DETAILED DESCRIPTION

The expressions “wt-%” and “mol-%,” are used herein to designate weight percentages and molar percentages, respectively. For ideal gases, “mol-%” is equal to percentage by volume. The term “substantially,” as used herein, refers to an extent of at least 95%. For example, the phrase “substantially all” may be replaced by “at least 95%.”

Embodiments of the invention are directed to apparatuses for, and methods for their use in, the transfer or conveyance of solid particles. These include particles of carbonaceous material generally, with particles of coal or particles of biomass being exemplary. Coal may refer, for example, to high quality anthracite or bituminous coal, or lesser quality subbituminous, lignite, or peat. The term “biomass” refers to renewable (non-fossil) substances derived from organisms living above the earth's surface or within the earth's oceans, rivers, and/or lakes. Representative biomass can include any plant material, or mixture of plant materials, such as a hardwood (e.g., whitewood), a softwood, a hardwood or softwood bark, lignin, algae, and/or lemna (sea weeds). Energy crops, or otherwise agricultural residues (e.g., logging residues) or other types of plant wastes or plant-derived wastes, may also be used as plant materials. Specific exemplary plant materials include corn fiber, corn stover, and sugar cane bagasse, in addition to “on-purpose” energy crops such as switchgrass, miscanthus, and algae. Short rotation forestry products, such as energy crops, include alder, ash, southern beech, birch, eucalyptus, poplar, willow, paper mulberry, Australian Blackwood, sycamore, and varieties of paulownia elongate. Other examples of suitable biomass include organic waste materials, such as wastepaper, construction, demolition wastes, digester sludge, sewage sludge, biosludge, de-inking sludge, aseptic packages, waste food, medium density fiberboard (MDF), and generally miscellaneous wastes having a solid component.

As noted above, biomass, according to particular embodiments, may be present in, or as a component of, municipal solid waste (MSW), or biomass may otherwise refer to a product derived from MSW, such as refuse derived fuel (RDF). Therefore, the solid particles in some embodiments may be particles of MSW or its derivative products. The biomass may therefore, in general, be present in combination with fossil-derived substances, or, more generally, in combination with non-biomass substances, with the biomass component being in the form of separate particles from particles of other components (e.g., fossil-derived substances, or generally non-biomass substances), and/or with the biomass component being consolidated into particles, together with such other components. In some embodiments, solid particles may comprise fossil-derived substances, or more generally, non-biomass substances, in the absence of biomass. Aside from coal, fossil-derived substances extend to solid, heavy petroleum fractions (e.g., petroleum coke).

Whether or not present in combination with biomass, the fossil-derived substances may include plastic and/or rubber (e.g., waste plastic and/or waste rubber such as waste tires), such that, for example, the solid particles may comprise particles of plastic, with particular types of plastic as described herein, and/or particles of rubber. In the case of biomass being present in combination with plastic and/or rubber, for example in the case of the solid particles being particles of MSW, the plastic and/or rubber may be present in individual solid particles, or otherwise in the bulk of the solid particles, in an amount from about 10 wt-% to about 85 wt-%, from about 20 wt-% to about 80 wt-%, or from about 35 wt-% to about 75 wt-%. In some embodiments, MSW may include, as plastics, any of polyethylene, polypropylene, poly(vinyl chloride) (PVC), polyesters, polyethylene terephthalate (PET) and/or polystyrene, being present in an amount within these ranges, or may include two or more of these plastics being present in a combined amount within these ranges. In general, the solid particles may therefore comprise, or consist of, materials that are conventionally understood as being difficult to process/monetize utilizing gasification, pyrolysis, or hydropyrolysis.

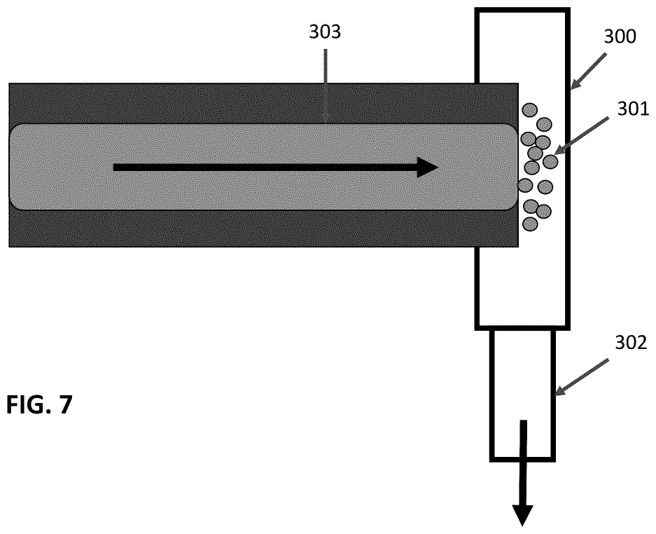

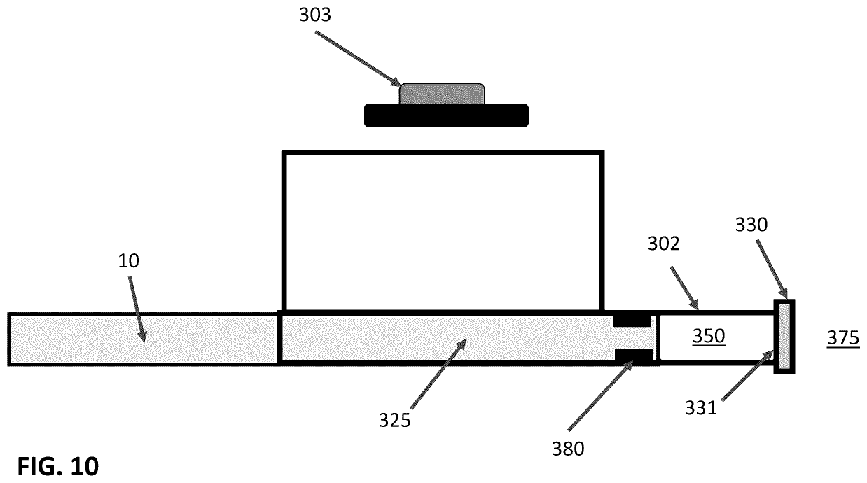

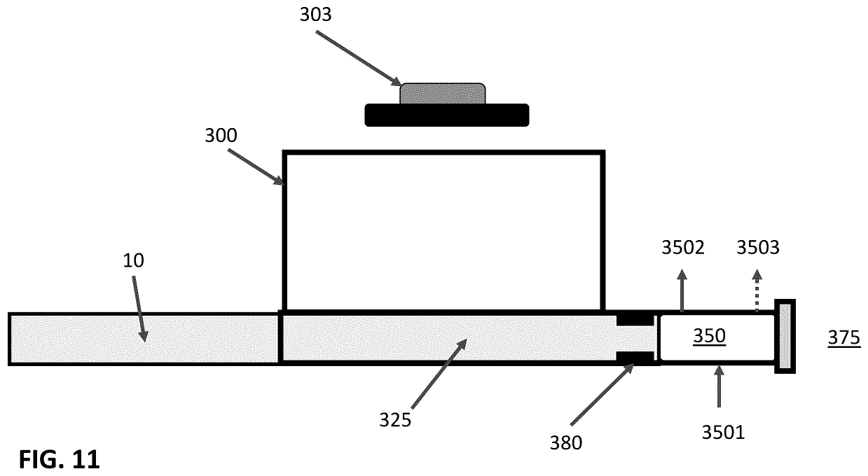

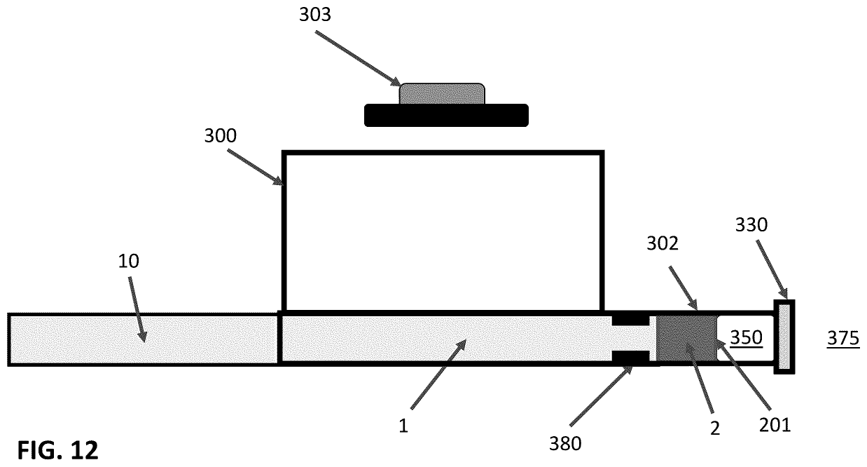

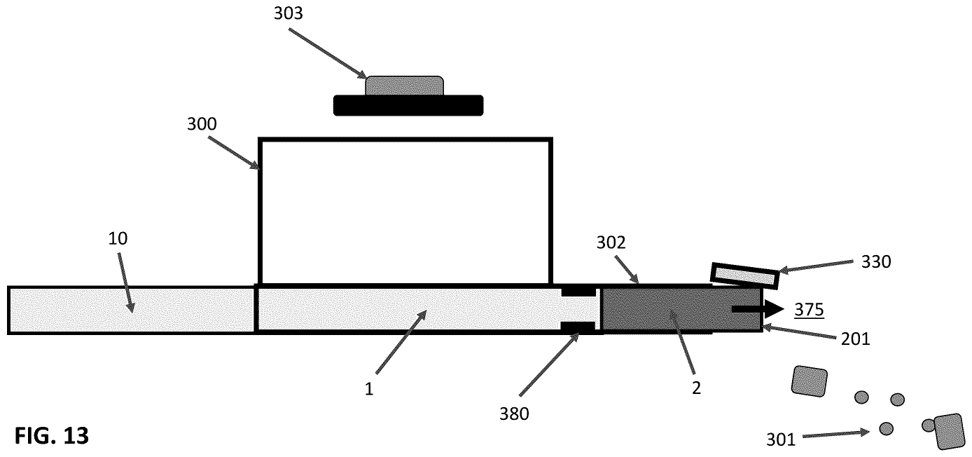

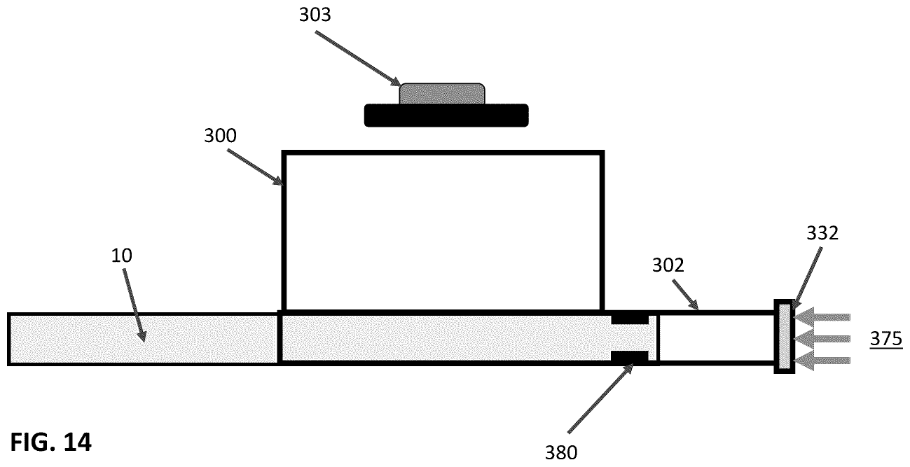

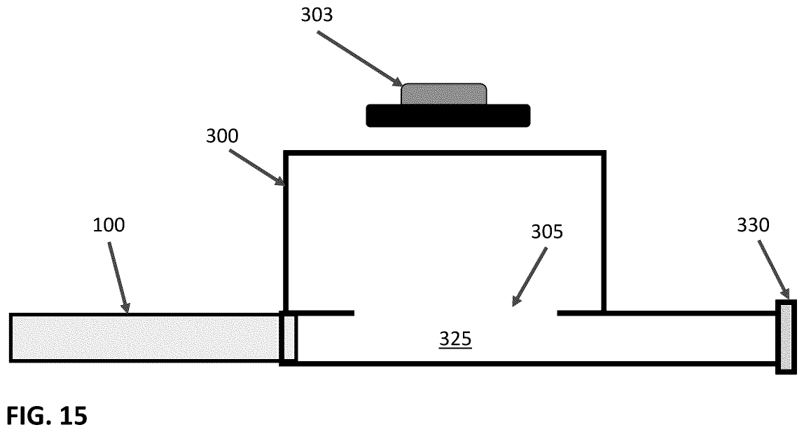

An exemplary loading method, for transferring solid particles from a first environment to a different (e.g., higher pressure) second environment, comprises the following steps that are preferably performed in the following order:
1. A conveyor belt or other type of solid particle conveying medium introduces (e.g., drops) a charge of the solid particles (e.g., feedstock) into an opening in an ambient conditioning zone, such as through a hopper or other simple guiding or funneling device that is aligned with this opening. The ambient conditioning zone may refer to a zone within a solids transmission conduit (e.g., pipe) that leads from a first environment of the ambient conditioning zone to a second (e.g., higher-pressure and/or higher-temperature) environment. Particular reference is made to FIGS. 7-9, including the further description of these figures below.
2. In a telescoping ram as described herein, the primary ram, within which the secondary ram is at least partially disposed, is displaced (e.g., moved forward) and transfers or pushes the solid particles into an intermediate environment of an equilibration chamber, which may define an isolation zone, insofar as this chamber may seal the solid particles within the intermediate environment, being separate from that of both of the ambient conditioning zone and the second environment of the process. The movement of the primary ram, or primary ram and secondary ram together, may transfer the solid particles toward, or possibly push these particles against, a closed valve (e.g., flapper valve, gate valve, or ball valve). The valve, at an interior surface facing the isolation zone, may form a second end of this zone, the first end of which may be formed by the front face of the secondary ram. The movement of the primary ram, to the extent this results in compaction of the space occupied by the charge of solid particles, may also serve to remove or force gas, and particularly air, from their initial, more loosely-held, or less dense volume. Particular reference is made to FIG. 10, including the further description of this figure below.
3. A switchable (e.g., live) seal, such as in the form of a collar or ring of flexible material inside the solids transmission conduit, is engaged (e.g., energized) to form a seal around the primary ram, such as in a location proximate its front end. In some embodiments, the live seal may be disposed around this ram at this location, and move together with the primary ram, as opposed to being fixed with respect to the solids transmission conduit. In either case, with the live seal activated and seal formed, the charge of solid particles may be prepared for further advancement out of the solids transmission conduit and into the second environment of the process, for example a pressurized surge vessel of this process. Preparation within the intermediate environment of the isolation zone may include changing this environment, such as by purging of the charge with inert gas, the application of vacuum, or flooding the charge with process gas (e.g., a gas comprising H₂, CO, and/or CO₂, for example in individual or combined amounts as described above with respect to the process environment). Preparation may include a combination of such conditioning steps, such as purging to remove air, followed by flooding with process gas. According to a particular embodiment, vacuum is applied to the charge to remove substantially all oxygen and/or air, as well as possibly moisture, the removal of which provides the added benefit of improving particle flowability. Following this application of vacuum, the environment of the charge may be replaced with process gas as described above, at a pressure substantially the same as, but preferably below, that of the second environment of the process. In this manner, the pressure differential being maintained by the valve (e.g., contributing to biasing the valve in a closed position) becomes significantly reduced or eliminated altogether. Particular reference is made to FIGS. 11 and 12, including the further description of these figures below.
4. The charge is ejected from the equilibration chamber, defining the isolation zone, via displacement of the secondary ram with respect to the primary ram, and through this chamber within the solids transmission conduit. That is, forward movement of the secondary ram, such that it projects outward from the primary ram, pushes the solid particles of the charge past the valve (e.g., through a flapper valve, gate valve, or ball valve), for example to an extent that these particles can drop freely into a surge vessel of the process with which the apparatus is integrated. In this manner, rapid movement of the secondary ram may impart momentum to both the charge, by direct impingement, as well as the valve. Displacement of this ram forward through the equilibration chamber opens the valve, for example by being forced upward in the case of a particular type of spring-biased flapper valve. Further displacement completely through the valve disperses (e.g., scatters and loosens) the charge as it is forced from the solids transmission conduit, by displacement of the secondary ram. Particular reference is made to FIG. 13, including the further description of this figure below.
5. The secondary ram is withdrawn into the primary ram, again by imparting relative movement between the rams. As the secondary ram is displaced backward through the valve and equilibration chamber, such movement may cause the valve to drop downward and back into its closed position. Closing of the valve against the front end of the solids transmission conduit may be accompanied by engagement of this valve with a compression seat (e.g., comprising an elastomer that is compatible with conditions of the process). It is also possible that retraction of the secondary ram through the equilibration chamber results in a vacuum-pulling effect that further biases (e.g., in combination with a spring or other mechanical component) the valve in its closed position, in view of the increased pressure differential across the valve, imparted as the process pressure of the second environment is re-applied to the front face of the valve (and transferred to a compression seat). According to one embodiment, vacuum in the equilibration chamber, during retraction of the secondary ram back into the primary ram, may be mitigated by introducing a suitable gas (e.g., an inert gas such as N₂) into this space to maintain some positive pressure (e.g., 1 bar absolute). In any event, this step may be concluded by withdrawal of the secondary ram, to its full extent, back into the primary ram, without solid particles being present in the equilibration chamber, and with the valve being maintained in a closed and sealing position, namely sealing the second environment of the process from that within the solids transmission conduit, due to the pressure differential between these environments. Particular reference is made to FIG. 14, including the further description of this figure below.
6. The switchable (e.g., live) seal is disengaged (e.g., de-energized), such that the first end of the equilibration chamber, and isolation zone defined by this chamber, is no longer sealed (e.g., from the ambient environment). The primary ram, into which the secondary ram has been retracted in this step, can therefore itself retract as a result of disengagement (e.g., de-energizing) of the live seal, which, when engaged, otherwise fixes the primary ram against the solids transmission conduit, at the position of the switchable seal. That is, with the switchable seal being de-energized, the primary ram (or both primary and secondary rams) can be withdrawn without damaging the material of the seal.
7. The primary ram is fully withdrawn, or fully retracted, along the length of the solids transmission conduit, which is devoid of solid particles. The conclusion this step may be characterized by the telescoping ram being back in its initial position, and configured for transferring a subsequent charge of solid particles according to steps 1-4 as described above. Particular reference is made to FIG. 15, including the further description of this figure below.

From the above description, it can be appreciated that ram movements in steps 5 to 7 (without solid particles being present in the solids transmission conduit) may constitute essentially the reverse of those ram movements described above in steps 4 to 2 (with solid particles being present in the solids transmission conduit), respectively. A number of details may be associated with to these “working” steps 2 to 4 and “resetting” steps 5-7, according to particular implementations. Embodiments of the invention are broadly directed, however, to methods comprising one or more steps (e.g., according to steps 2 and/or 7) in which primary and secondary rams are moved or displaced together (i.e., with no relative movement between the rams), and further comprise one or more steps (e.g., according to steps 4 and/or 5) in which the primary and second rams are moved or displaced relative to one another. Such methods may further comprise one or more steps (e.g., according to steps 3 and/or 6), in which a seal for isolating an intermediate environment, between a first environment (e.g., of an ambient condition zone) and a second environment (e.g., of a process), is activated and/or deactivated (engaged or disengaged). Features of these methods are particularly advantageous, for reasons described herein, in the loading of solid particles. In an analogous manner, embodiments of the invention are broadly directed to devices comprising primary and secondary rams, which are configured for being moved or displaced together (jointly), as well as configured for independent movement or displacement of the secondary ram relative to the primary ram. In particular embodiments, the independent movement may occur while fixing or preventing movement between the primary ram and solids transmission conduit, such as by activating (engaging) a seal between these components as described herein. The devices may further be configured for such joint or independent ram movement, being relative to a stationary pressure shell as described herein. Features of these devices are particularly advantageous, for reasons described herein, in telescoping rams.

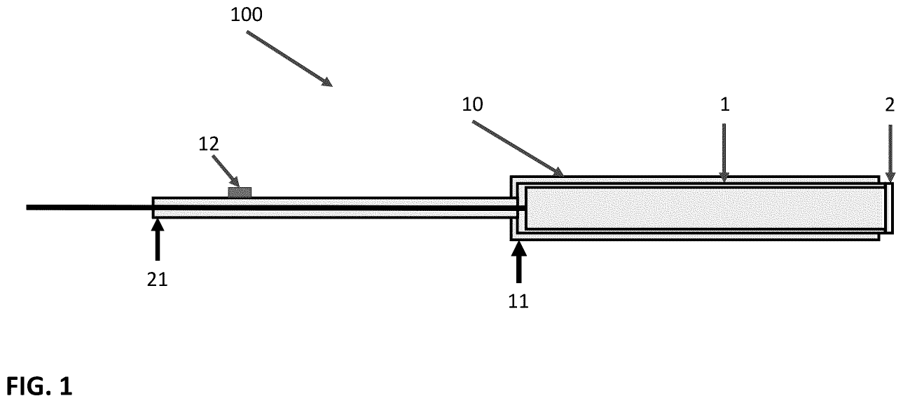

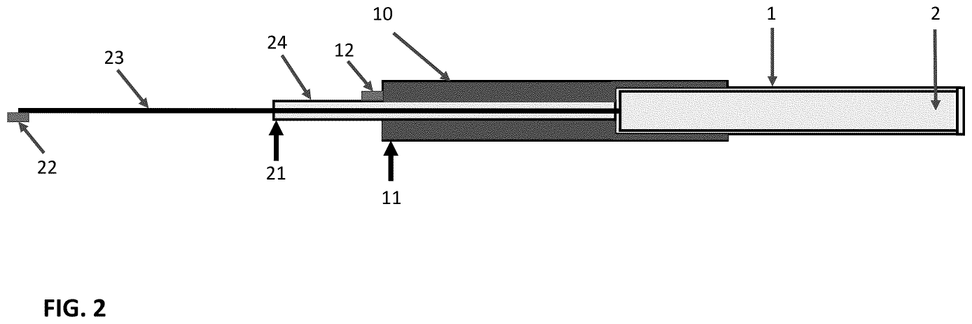

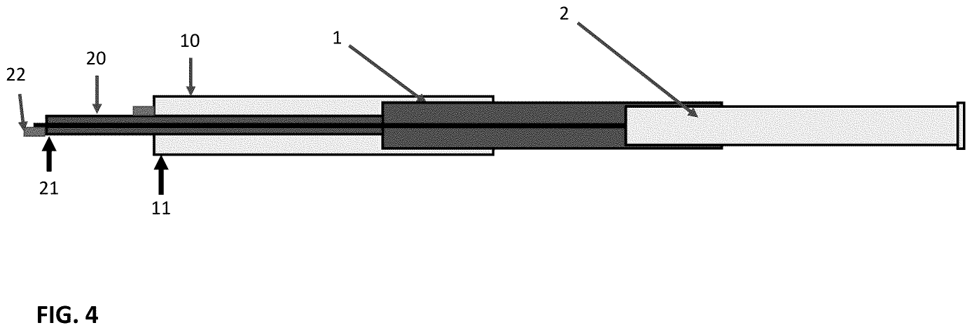

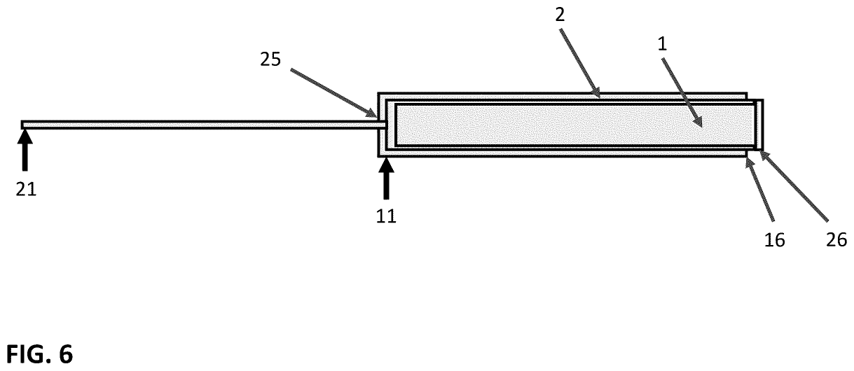

FIGS. 1-6 illustrate telescoping rams, including various positions of the primary and secondary rams, together with other possible, associated features. For example, FIG. 1 illustrates a configuration with both rams being retracted into a primary pressure shell, and being displaceable in response to pressure being applied within this shell. FIGS. 2 and 3 illustrate this displacement of the primary and secondary rams together. FIGS. 4 and 5 illustrate the independent displacement of the secondary ram, relative to the primary ram, in response to pressure being applied in a secondary pressure shell. FIG. 6 illustrates functions of the actuation tube, in terms of guiding displacement of the primary and secondary rams jointly, as well as causing, through pressurization of the secondary pressure shell, displacement of the secondary ram relative to the primary ram independently.

With reference to these figures, but with the understanding that not all features shown are required, particular embodiments of the invention are directed to a telescoping ram 100, comprising primary ram 1 and secondary ram 2, with secondary ram 2 being at least partly disposed within primary ram 1, and with secondary ram 2 being configured for displacement relative to (projection or telescoping from) the primary ram 1. In addition, primary ram 1 may be at least partly disposed within primary pressure shell 10, such as within primary pressure shell cavity 105, formed by an interior surface of the primary pressure shell. Respective exterior surfaces of the secondary ram, primary ram, and primary pressure shell, namely secondary ram body exterior surface 212, primary ram body exterior surface 112, and primary pressure shell body exterior surface 1012 may be cylindrical and extend (e.g., horizontally in operation) along, or share, a common central axis (e.g., axis along which primary ram 1 may be displaced relative to primary pressure shell 10, and/or along which secondary ram 2 may be displaced relative to primary ram 1). This common central axis may be aligned with, or correspond to, secondary ram indexing rod 23. Front edges of the rams, namely primary ram front edge 16 and/or secondary ram front edge 26, may be chamfered to help remove solid particles from (lift them up and out of) these locations, thereby hindering undesired accumulation.

In particular embodiments, secondary ram 2 may be within secondary pressure cell cavity 205, at least a portion of which is formed by an interior surface, such as back base interior surface 121 together with body interior surface 111 (which are preferably circular and cylindrical surfaces, respectively) of primary ram 1. At least a portion of an exterior surface, such as back base exterior surface 222 and/or body exterior surface 212 (which are also preferably circular and cylindrical surfaces, respectively) of secondary ram 2 may conform to this interior surface of primary ram 1. At least a portion of an exterior surface, such as back base exterior surface 122 and/or body exterior surface 112 (which are also preferably circular and cylindrical surfaces, respectively) of primary ram 1 may, in turn, conform to the interior surface of primary pressure shell 10, such as primary pressure shell back base interior surface 1021 and/or primary pressure shell body interior surface 1011 (which are also preferably circular and cylindrical surfaces, respectively). Likewise, to the extent that the interior surface of the primary ram 1 may form at least a portion of secondary pressure shell 20, which may be pressurized to cause independent displacement of secondary ram 2 with respect to primary ram 1, secondary ram 2 may conform to at least a portion of the interior surface of secondary pressure shell 20, as well as at least a portion of the interior surface of primary ram 1.

For transferring solid particles, primary ram 1, or both primary ram 1 and secondary ram 2 together (jointly), for example with secondary ram 2 being in a fully retracted position relative to primary ram 1, are configured for displacement relative to (projection or telescoping from) primary pressure shell 10. This displacement may be characterized by movement of the rams together, such as horizontally in operation, relative to, and responsive to pressure applied in, primary pressure shell 10. For example, primary pressure shell 10 may be sealingly engaged with at least a portion of the exterior surface of the primary ram, such as with primary ram back base exterior surface 122 that may be a cylindrical surface in the form of a back plate. A change in pressure (e.g., pressurization or depressurization) in primary pressure shell 10 can cause displacement of primary ram 1 over a range of movement (or distance) from a fully retracted position (e.g., upon depressurization) to a fully extended position (e.g., upon pressurization). Advantageously, secondary ram 2 is configured for independent displacement with respect to primary ram 2. This independent displacement may be characterized by movement of the secondary ram alone, such as horizontally in operation, relative to the primary ram and primary pressure shell, and responsive to pressure applied in secondary pressure shell 20. For example, secondary pressure shell 20 may be sealingly engaged with at least a portion of the secondary ram, such as with secondary ram back base exterior surface 222 that may be a circular surface in the form of a back plate. A change in pressure (e.g., pressurization or depressurization) in secondary pressure shell 20 can cause displacement of secondary ram 2 over a range of movement (or distance) from a fully retracted position (e.g., upon depressurization) to a fully extended position (e.g., upon pressurization).

Pressurization and depressurization of the pressure shells for controlling ram movement may be realized by introduction and removal of gas or other hydraulic fluid through primary pressure port 11 of primary pressure shell 10 and/or through secondary pressure port 21 of secondary pressure shell 20. For example, the primary and secondary rams may be retracted together by pulling vacuum, applying negative hydraulic pressure, or otherwise depressurizing primary pressure shell 10 through primary pressure port 11. The secondary ram may be retracted independently of the primary ram, in the same manner, but utilizing secondary pressure port 21 of secondary pressure shell 20 for pressurizing/depressurizing this shell. Alternatively to, or in combination with, hydraulic actuation of the rams, mechanical devices may be utilized to impart ram movement. For example, in the case of retraction, return springs may be utilized to pull the primary and/or secondary rams backward for return to their retracted, or partially retracted, positions. Representative telescoping rams may therefore broadly further include: primary pressure port 11 for introduction of primary pressurization fluid to, and/or removal of primary pressurization fluid from, primary pressure cell 10, and/or secondary pressure port 21 for introduction of secondary pressurization fluid to, and/or removal of secondary pressurization fluid from, secondary pressure cell 20. The primary and/or secondary pressurization fluids may be, for example, a gas such as air or nitrogen, or a liquid such as hydraulic oil. The primary and secondary pressurization fluids may be the same or different.

In some embodiments, at least a portion of secondary pressure cell 20 may extend from outside of primary pressure cell 10 to within this pressure cell. For example, secondary pressure cell 20 may extend through a back base of primary pressure cell 10, with primary pressure cell back base exterior surface 1022 being isolated from pressure within primary pressure cell 10, and primary cell back base interior surface 1021 being exposed to pressure within primary pressure cell 10. The outside-extending (or protruding) portion of the secondary pressure cell may be, for example, actuation tube 24 that forms sliding seal 25 with primary pressure cell 10. In this case, actuation tube 24 may be slidably engaged with this cell, and different sections of exterior surface may be respectively isolated from, and exposed to, pressure within primary pressure cell 10. For example, as illustrated in FIG. 5, actuation tube rear body exterior surface portion 242a may be outside of (isolated from) this pressure, whereas front body exterior surface portion 242b may be inside of (exposed to) this pressure. Preferably, actuation tube 24, forming part of secondary pressure cell 20 (i.e., containing pressure within this cell), slides for movement of primary ram 1 and secondary ram 2, such as when being axially displaced together (jointly) with respect to primary pressure cell 10. In allowing for this displacement, in combination with sealing of secondary pressure cell 20 due to sliding seal 25, actuation tube 24 may extend at one end to a back base, or more particularly to back base exterior surface 122, of primary ram 1. The sliding seal may allow actuation tube 24 to slide through the back base (or back plate) of the primary pressure shell. In this manner, therefore, sliding or displacement of actuation tube 24 may dictate and/or guide movement of the primary and secondary rams together, with such movement being actuated by pressurization of primary pressure shell 10 (e.g., through primary pressure port 11), whereas pressurization of secondary pressure shell 20 (e.g., through secondary pressure port 21) may dictate movement of the secondary ram independently of the primary ram, with such movement being guided further by secondary ram indexing rod 23.

In representative telescoping rams, back base interior surface 1021 of primary pressure cell 10 defines a fully retracted position of primary ram 1, and/or contact between primary ram stop 12 and back base exterior surface 1022 of primary pressure cell 10 defines a fully extended position of primary ram 1. The primary ram stop may be disposed on an exterior surface of secondary pressure cell 20, such as an exterior surface of actuation tube 24 and, in more particular embodiments, at actuation tube rear body exterior surface portion 242a. Further with respect to guiding and regulating (e.g., limiting) movement of primary and/or secondary rams, secondary ram indexing rod 23 may extend from outside of secondary pressure shell 20 to within this pressure cell. For example, secondary ram indexing rod 23 may extend through a back base of secondary pressure cell 20, such as through a back base of actuation tube 24, with actuation tube back base exterior surface 2422 being isolated from pressure within secondary pressure cell 20, and actuation tube back base interior surface 2421 being exposed to pressure within secondary pressure cell 20. The secondary ram indexing rod may extend at one end (e.g., a forward end) to a back base of the secondary ram, such as to secondary ram back base exterior surface 222. In representative telescoping rams, back base interior surface 121 of primary ram 1 defines a fully retracted position of the secondary ram 2, and/or contact between secondary ram stop 22 and a back base exterior surface of the secondary pressure cell, such as back base exterior surface 2422 of actuation tube 24, defines a fully extended position of secondary ram 2. In some embodiments, secondary ram stop 22 may be disposed on secondary ram indexing rod 23.

A two-stage telescoping ram may be considered a particular type of telescoping ram and a preferred telescoping ram according to embodiments of devices, apparatuses for the application of these devices in the transfer of solid particles, and processes that integrate these devices and apparatuses for the conversion of such solid particles to higher-value products. A two-stage telescoping ram may be characterized by the primary ram and secondary ram being the only rams of the device. Telescoping rams, however, nonetheless encompass devices having more than two, such as three, four, or five rams, with their implementation in apparatuses and processes described herein being apparent to those having skill in the art, with the knowledge gained from the present disclosure.

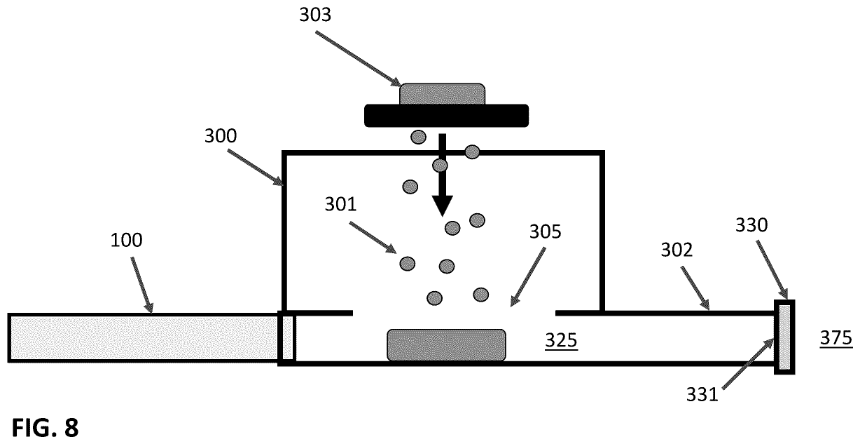

FIGS. 8-16 illustrate side views of apparatuses for transferring solid particles and various features. These figures further illustrate steps in methods for transferring solid particles, with exemplary method steps as described above.

With reference to these figures, but with the understanding that not all features shown are required, particular embodiments of the invention are directed to a method of transferring solid particles (e.g., of loose feedstock comprising biomass or other carbonaceous material). The method comprises displacing the primary and secondary rams of a telescoping ram according to any of the embodiments described herein. More particularly, this displacing causes the transfer of solid particles 301 from one environment, namely a first environment such as that of ambient conditioning zone 325, to second environment 375, such as that of a process with which the telescoping ram is integrated, or process fed by this device. The process may be used for transforming the solid particles, for example by gasification, pyrolysis, or hydropyrolysis to yield synthesis gas as a valuable precursor to renewable fuels (e.g., sustainable aviation fuel). The second environment may be pressurized to above-ambient pressure, whereas the first embodiment may be at ambient pressure, or, more generally, the pressure of the second environment may exceed that of the first environment, such that transfer of the solid particles causes their movement through a pressure gradient. Such gradient may, in representative embodiments exceed any of the following thresholds: about 1 bar (14.5 psi), about 5 bar (72 psi), about 10 bar (145 psi), about 20 bar (290 psi), 30 bar (435 psi), about 50 bar (725 psi), or about 100 bar (1450 psi). The displacing and transfer may be effected by impacting or contacting of the secondary ram (e.g., at its front face) with the solid particles, and mechanical forcing of these particles, caused by primary and secondary ram movement as described herein. In some embodiments, transfer from the first to the second environment may proceed through an intermediate environment, such as that of isolation zone 350. In the case of utilizing such intermediate environment, this may have a position and/or a pressure that is between that of the first and second environments.

Particular methods for transferring solid particles 301 may comprise: (a) with the primary and secondary rams of a telescoping ram described herein being in an at least partially retracted position that forms opening 305 in ambient conditioning zone 325 of solids transmission conduit 302 (e.g., pipe), loading the solid particles into this zone. This loading may occur from above ambient conditioning zone 325, and more particularly with the opening being located at the top of this zone. The at least partially retracted positions of the rams may, in preferred embodiments as an initial setting for loading the solid particles, be more particularly their fully retracted positions, for example corresponding to their most rearward positions, within the primary pressure shell or with respect to the solids transmission conduit, with reference to the direction of transfer of the solid particles being the forward direction. In some embodiments, such as illustrated in FIG. 7, step (a) may be performed in conjunction with operating solid particle conveying medium 303 (e.g., a conveyor belt) to introduce solid particles 301 into loading hopper 300 that is aligned with (e.g., above) the opening formed in the ambient conditioning zone. The solid particle conveying medium may, for example, operate intermittently, such as in conjunction (or being synchronized) with operation of the rams as described herein, to cause introduction of the solid particles into the ambient conditioning zone, at time intervals in which the opening of this zone is formed. The solid particle conveying medium may therefore intermittently cause solid particles 301 (e.g., loose particles of feedstock) to drop into loading hopper 300 from above. The solids transmission conduit (e.g., pipe), with which the primary and secondary rams are aligned, may extend from a side of the loading hopper for transfer of the solid particles forward, in this direction of extension.

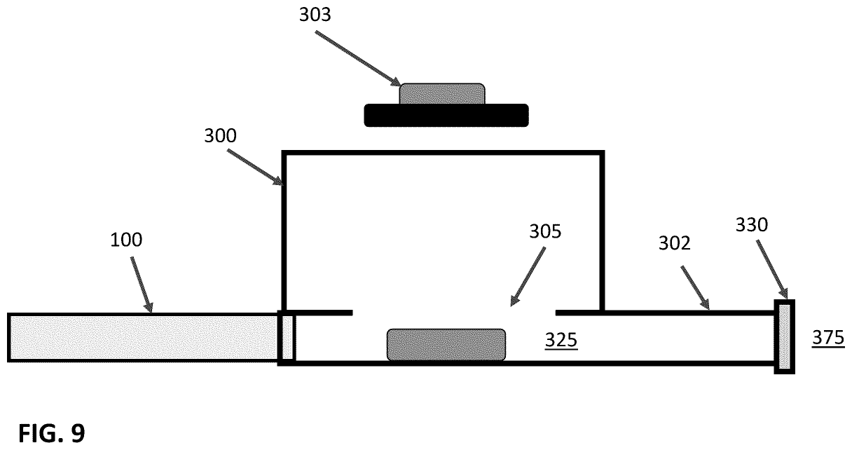

FIG. 8 illustrates telescoping ram 100, with the primary and secondary rams, being aligned with solids transmission conduit 302, and at their at least partially retracted (e.g., fully retracted) positions. The loading hopper (e.g., ambient conditioning hopper) may have a rectangular, circular, or other shaped cross section that may be constant in the axial (e.g., vertical) direction in which the solid particles are dropped. Otherwise, such cross section may be expanded at the top, where solid particle conveying medium 303 delivers the solid particles, or alternatively may be expanded at the bottom, where solid particles pass through opening 305. That is, according to some embodiments, the loading hopper does not converge toward the bottom, which may be important for avoiding particle bridging or agglomeration (e.g., due to wetness or tackiness) of certain feedstocks during loading. Regardless of the particular geometry of the loading hopper, accumulation of solid particles in solids transmission conduit 302, such as below opening 305 formed by the primary and secondary rams being in their at least partially retracted positions, results in a discreet feedstock charge to be transferred in a given cycle of operation of telescoping ram 100. This transfer occurs through solids transmission conduit 302 and then out through valve 330 into second environment 375 of the process. In particular embodiments, with regard to equipment considerations, the valve may be, more particularly, a flapper valve, for example hinged at the top and having an elastomer seat for sealing solids transmission conduit 302 from second environment 375. Other valve types include a gate valve or a ball valve. The second environment may be, more particularly, a surge vessel that contains this environment (e.g., with respect to pressure, temperature, and gas composition, such as those as described above). Whereas FIG. 8 illustrates solid particles dropping through opening 305, FIG. 9 illustrates a subsequent point in time after a sufficient feedstock charge is loaded and solid particle conveying medium 303 then ceases delivery of solid particles 301.

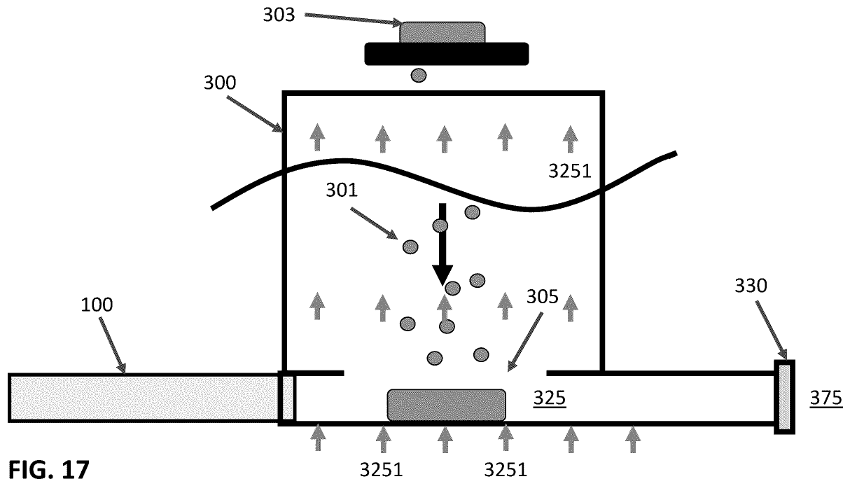

During step (a) of loading the solid particles into ambient conditioning zone 325, with the primary and secondary rams being in their at least partially retracted (e.g., fully retracted) positions, particular methods may comprise removing air from this zone. To achieve this by purging, ambient conditioning zone purge gas 3251 can be directed through ambient conditioning zone 325, such as upwardly through this zone and possibly further into loading hopper 300, which may, in this case, also be referred to as an ambient conditioning hopper. Gas used for purging in this regard can be an inert gas such as nitrogen, or a gas that is more dense than air, with CO₂ (possibly cooled) being representative. A particular embodiment of using ambient conditioning zone purge gas 3251 for displacing air upward and out of loading hopper 300 is illustrated in FIG. 17, with the curved (wavy) line showing possible elongation of this hopper.

In addition to step (a) as described above, representative methods may further comprise: (b) displacing the primary ram (e.g., by extending it) from the at least partially retracted position to an at least partially extended position, causing movement of a front end of the secondary ram through ambient conditioning zone 325 (which may thereby close the opening of this zone through which solid particles are initially loaded) and also the transfer of the solid particles, for example out of the ambient conditioning zone that is in a first environment, and into second environment 375 of the process, with such transfer optionally proceeding through an intermediate environment, such as that of isolation zone 350. For carrying out this solid particle transfer by ram displacement, the telescoping ram, or more particularly the primary and secondary rams, may be aligned with the solids transmission conduit, such that at least the front end of a secondary ram is configured for displacement or extension through the ambient conditioning zone and possibly also through the optional isolation zone. Advantageously, the primary and/or secondary rams, in combination with the solids transmission conduit, can transfer a wide range of solid particles into environments that are characteristic of various processes described herein, which may operate under a correspondingly wide range of conditions.

According to particular methods, in step (b), the transferring of the solid particles (e.g., into the second environment) may further comprise (or be performed by) displacing the secondary ram (e.g., by extending it in the forward direction) with respect to the primary ram to cause further transfer of the solid particles in a forward direction, beyond an extent to which the solid particles are transferred in this direction by displacing the primary and secondary rams together. For example, in step (b), the movement of the front end of the secondary ram through ambient conditioning zone 325 may cause (e.g., by a first phase of ram motion) an initial transfer of the solid particles from ambient conditioning zone 325 to an equilibration chamber, which may define isolation zone 350 within solids transmission conduit 302. In this case, the first phase of ram motion, in which both the primary and secondary rams move together, may isolate (e.g., seal) the isolation zone from the ambient conditioning zone. For example, in more particular embodiments, this first phase of ram motion that causes movement of the front end of the secondary ram through ambient conditioning zone 325, may be followed by pressurization of live seal ring 380 (or possibly a region surrounding this ring), or otherwise activating a seal between the primary ram and the solids transmission conduit. For this purpose, a suitable sealing/gasketing material (e.g., Buna rubber or other elastomer) may be used.

As illustrated in FIGS. 10 and 11, for example, a live seal ring may be at an axial position between ambient conditioning zone 325 and isolation zone 350, or namely at a forward end of the former and a rearward end with respect to the latter. The live seal ring may surround the primary and/or secondary ram(s) proximate the front end of the ram(s). Activation of live seal ring 380 may occur with both primary and secondary rams having been extended (e.g., through ambient conditioning zone) together, and through pressurization of this ring or a region surrounding it, such as by filling with a high-pressure bearing gas or hydraulic fluid. As a result of activation, solid particles of feedstock may be isolated or sealed in an intermediate environment of isolation zone 350, between front end 201 of the secondary ram and valve 330. A relatively higher pressure in second environment 375 of the process, compared to that in isolation zone 350, can facilitate biasing of valve 330 in the closed position to maintain sealing between this environment and zone.

Representative methods may therefore comprise, following displacement of the front end of the secondary ram through the ambient conditioning zone, activating a live seal ring by pressurization, or by flowing a bearing gas that effectively seals isolation zone 350. Methods may further comprise changing an environment of isolation zone 350, such as to an intermediate environment, which may differ, in terms of pressure and/or surrounding gas composition, from the first environment of the ambient conditioning zone and/or from the second environment. The environment of the isolation zone may be changed to more closely approximate that of the process, for example to “transition” the solid particles from the initial environment of ambient conditioning zone 325 to that of isolation zone 350. According to particular embodiments, for example, changing the environment of isolation zone 350 may comprise removing air, such that, with respect to the accompanying removal of oxygen, this may provide an intermediate environment that is inert, or may provide an intermediate environment with a surrounding gas composition of the process. In the case of removing air, this can be achieved by a combination of purging and venting, optionally together with drawing a vacuum. Gas used for purging, namely an isolation zone purge gas, can be an inert gas such as nitrogen or can be process vapor. With reference to FIG. 11, options for transition or equilibration of solid particles, in preparation for their introduction into the second environment, may include flowing isolation zone purge gas 3501 into isolation zone 350. To facilitate gas displacement (e.g., air displacement), (i) prior to flowing of this purge gas, isolation zone 350 may be evacuated through isolation zone vacuum 3503, and/or (ii) subsequent to or during flowing of this purge gas, isolation zone 350 may be vented through isolation zone vent 3502. The purge gas may be, for example, an inert gas or a gas approximating that present in, or actually used in, the second environment of the process. By using a simulated or actual process gas, the “flooding” of the isolation zone 350 with such gas can advantageously avoid the need for supplemental inert gas, while still preventing the introduction of air and/or inert gas into the environment of the process (e.g., vapor environment of a surge vessel of the process).

Representative methods may further comprise, in addition to steps (a) and (b) as described herein, step (c) of displacing the secondary ram (e.g., by extending it in the forward direction) from an at least partially retracted position (e.g., a fully retracted position, with respect to the primary ram) to an at least partially extended position (e.g., a fully extended position, with respect to the primary ram). This causes movement of the front end (or front face) of the secondary ram, and the transferring of the solid particles, to outside of the solids transmission conduit. Transfer of solid particles according to steps (a), (b), and (c) as described herein, may therefore involve their initial transfer out of ambient conditioning zone 325 in the first (e.g., ambient) environment to the second environment of the process, outside the solids transmission conduit, and optionally through an intermediate environment of isolation zone 350.

In more particular embodiments, step (c) may comprise substep (c1) of displacing the secondary ram (e.g., by extending it in the forward direction) from the at least partially retracted position to an intermediate extended position with respect to the primary ram. For example, this displacing of secondary ram 2 may cause it to protrude, in a telescoping manner, from the front end (or front face) of the primary ram, following both primary and secondary rams having been extended together (e.g., through the ambient conditioning zone), and also following activation of live seal ring 380. As illustrated in FIG. 12, this initial displacement of the secondary ram relative to the primary ram may reduce the volume of isolation zone 350 and thereby increase the pressure within this zone (e.g., to above ambient pressure). In this manner, the environment of the isolation zone may, relative to that previously existing in the ambient conditioning zone, be suitably adjusted directionally toward that of the process, in terms of either or both of the surrounding gas composition and its pressure. Preferably, however, any intermediate pressure maintained in isolation zone 350, such as for a time sufficient to perform gas displacement and/or evacuation, followed by pressurization, is below that of the process, to ensure that valve 330 (e.g., a flapper valve) separating isolation zone 350 from second environment 375 remains biased in a closed position, until the subsequent release/ejection of the solid particles into this environment. Transformation of the gas composition and/or pressure in isolation zone 350 may be performed effectively by maintaining the live seal as described above, such as by pressurization of, or by flowing a bearing gas through, live seal ring 380, which may surround primary ram 1, proximate its front end.

According to a particular embodiment in which gas pressure in isolation zone 350 is equilibrated or transitioned toward that of second environment 375, secondary ram 2 is extended until the gas pressure in this zone surrounding the solid particles is slightly below (e.g., below, but within about 1 bar, within about 0.5 bar, or within about 0.1 bar) of that of the second environment, being separated from the isolation zone by valve 330. Maintaining activation (e.g., pressurization) of live seal 380 ensures that gas in isolation zone 350 cannot escape in the rearward direction, back toward loading hopper 300. Also during transition or equilibration, front end 201 of the secondary ram (e.g., at its front face), which forms one end of the isolation zone, impacts primarily gas pressure and does not appreciably densify the charge of solid particles, thereby preventing compaction and undesired formation of a solid plug. However, in some embodiments, an increase in density within the isolation zone may be desired (e.g., by increasing the initial displacement of the secondary ram), in order to achieve greater overall volumetric capacity of solid particle transfer.

In the more particular embodiments described above, step (c) may comprise substep (c2) of further displacing the secondary ram (e.g., by further extending it in the forward direction) to the at least partially extended (e.g., fully extended) position with respect to the primary ram. In terms of substeps (c1) and (c2), both the intermediate and the at least partially extended positions of the secondary ram refer to positions that are attained following (i) both the primary and secondary rams having been displaced together through ambient conditioning zone 325 and (ii) activation and maintaining of live seal ring 380. The intermediate position of the secondary ram is more fully extended with respect to the primary ram, compared to the at least partially retracted position, and the at least partially extended position is more fully extended with respect to the primary ram, compared to the intermediate position.

Displacing the secondary ram to the at least partially extended (e.g., fully extended) position may force the opening of valve 330. This may be, more particularly, a flapper valve or other valve that is biased in the closed position due to mechanical (e.g., spring) force and/or from process pressure. The valve is normally positioned at an end (e.g., front end) of solids transmission conduit 302. When closed, valve 330 isolates second environment 375 from the first environment of ambient conditioning zone 325, as well as from an intermediate environment of isolation zone 350. According to step (c), displacing the secondary ram causes it to impinge upon, or push, valve 300 with sufficient force to overcome any force and/or pressure biasing it to the closed position. Opening of valve 300 allows front end 201 of secondary ram 2 to extend completely through solids transmission conduit 302 and thereby force solid particles 301 outside of this conduit and into second environment, as illustrated in FIG. 13. According to an exemplary option for transferring solid particles external to solids transmission conduit 302, solid particles 301 are “pushed” through valve 330 via displacement of secondary ram 2 to its fully extended position. Momentum acquired by the solid particles, together with an increase of the surrounding gas pressure to above that of second environment 375 of the process, forces valve 330 to open and results in distribution (e.g., spraying or ejection) of the solid particles outward, such as into a top end of a surge vessel of the process. A temporarily higher pressure may surround the solid particles immediately prior to opening of valve 330. Distribution of the solid particles to outside of solids transmission conduit 302 may therefore result in gas expansion in the corresponding, temporarily lower pressure of second environment 375, hindering undesired compaction and/or plug formation of the solid particles.

Returning a telescoping ram back to its initial position, following the transfer of the solid particles to the second environment of the process, may involve a number of steps. For example, subsequent to steps (a), (b), and (c) as described herein and with step (c) optionally comprising substeps (c1) and (c2), representative methods may comprise (d) displacing the secondary ram (e.g., by retracting it in the rearward direction), causing movement of its front end (or front face) from outside of, to within, solids transmission conduit 302. This step may, more particularly, comprise displacing the secondary ram (e.g., by retracting it in the rearward direction) to the at least partially retracted position with respect to the primary ram, as described herein. This may be, for example, the fully retracted position that forms opening 305 in ambient conditioning zone 325 of solids transmission conduit 302. Retracting of the secondary ram may cause the closing of valve 330 at the front end of this conduit, as the secondary ram is retracted back through the valve, allowing pressure and/or other (e.g., mechanical) force, as described herein, to again bias it to the closed position. The valve closing, together with maintaining live seal 380, may again allow valve 330 to isolate second environment 375 from the first environment of ambient conditioning zone 325, as well as from an intermediate environment of isolation zone 350.

As with step (c), described above, in more particular embodiments step (d) may also comprise one or more substeps, such as substep (d1) of displacing the secondary ram (e.g., by retracting it in the rearward direction) from the at least partially extended position to an intermediate retracted position with respect to the primary ram. This may correspond to the intermediate extended position, for increasing pressure in the isolation zone as described above with respect to substep (c1). By performing substep (d1) in conjunction with maintaining the switchable (e.g., live) seal as described herein, a vacuum may be drawn in a zone within solids transmission conduit 302 that may correspond to isolation zone 350. Otherwise, depending on the intermediate retracted position of the secondary ram, this zone may correspond, relative to isolation zone 350, a smaller or larger zone between (i) secondary ram 2, or more specifically at the front face of its front end 201 and (ii) valve 330, or more specifically its back face 331. In any event, drawing a vacuum, while maintaining the switchable seal, may be used to facilitate closing of valve 330, by increasing the biasing pressure differential, due to the presence of process pressure of second environment 375 on a side of this valve.

In these more particular embodiments, step (d) may comprise substep (d2) of further displacing the secondary ram (e.g., by further retracting it in the rearward direction) to the at least partially retracted (e.g., fully retracted) position with respect to the primary ram, which position again forms opening 305 in ambient conditioning zone 325 of solids transmission conduit 302. Representative methods, following substep (d1) and prior to substep (d2), may comprise deactivating live seal ring 380 by depressurization or by ceasing flow of bearing gas as described herein. Following deactivating live seal ring 380, primary and secondary rams may again be displaced together (jointly), and thereby retracted further, such as to a position that is characteristic of the initial position of the telescoping ram.

A particular method according to which the primary and secondary rams of a telescoping ram can be reset is illustrated in FIGS. 14 and 15. This may be initiated by retracting the secondary ram, such that its front end is moved from outside of, to within, solids transmission conduit 302, and the valve is closed and re-seated. For example, the retracting of the secondary ram may cause vacuum within the solids transmission conduit, and more specifically the volume in this conduit through which the secondary ram is retracted. Pressure differential between process pressure in second environment 375 and the vacuum may thereby induce a re-seating force on the valve against the solids transmission conduit, or against a seat of the valve that is formed of a suitable sealing/gasketing material, such as Buna rubber or other elastomer. According to an embodiment in which this pressure differential, resulting in a net force against front face 332 of valve 330, is sufficient for valve seating and sealing, elimination of a valve actuator can result in significant capital and/or operating expenses. In some embodiments, however, an actuator or other separate valve control, for example which imparts an opening or closing force, depending on the position of the secondary ram, may be used to facilitate, or possibly independently govern, the opening and closing of valve 330. In facilitating valve operation, such actuator or other separate valve control (e.g., motor) may work in conjunction with pressure and/or other (e.g., mechanical) forces as described herein, acting on valve 330, for example in the case of an actuated flapper valve. Other types of valves may also be actuated, for example the solids transmission conduit may otherwise be equipped with an actuated gave valve or actuated ball valve, either of which may controlled (opened or closed) with an actuator or other control system. According to a specific embodiment, in which exclusive reliance on the “kick,” or independent displacement, action of the secondary ram to open and close the valve is to be avoided, this valve may be equipped with a quick-acting actuator. Such actuator may, for example, be configured to open and close the valve as the secondary ram begins and ends (extends and retracts) its independent movements, relative to the primary ram. For completion of the reset of the primary and secondary rams, releasing bearing gas pressure or flow to depressurize or deactivate the switchable seal ring allows these rams to be retracted together, to their “starting position” that re-forms opening 305 in ambient conditioning zone 325. This position may be characterized by the primary and secondary rams being in their at least partially retracted, and preferably fully retracted, positions.

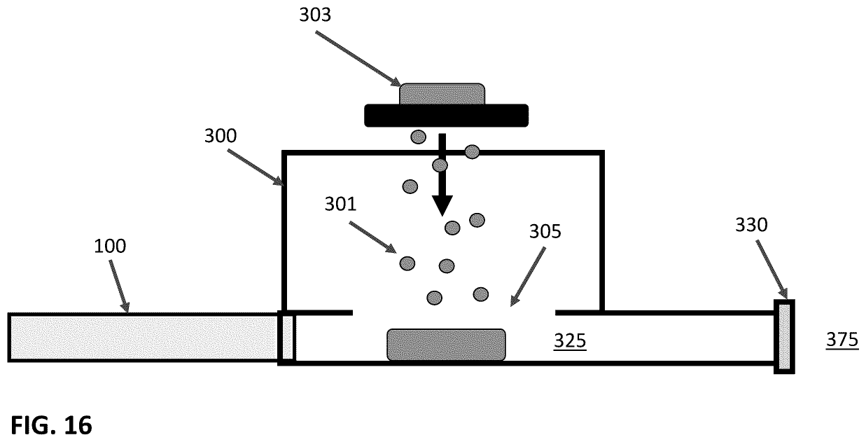

Certain embodiments are directed to methods in which steps (a) to (d) as described herein, with step (c) optionally comprising substeps (c1) and (c2) and/or with step (d) optionally comprising substeps (d1) and (d2), are performed repeatedly to cause transferring of separate or discreet charges of the solid particles from the first environment of the ambient conditioning zone to the second environment of the process, and optionally occurring through intervening preparation (transition or equilibration) steps in an isolation zone. For example, repeated steps (a) may comprise loading separate charges of solid particles, successively at time intervals corresponding to the primary and secondary rams being in their retracted positions to form the opening in the ambient conditioning zone. Intermittent introductions of the separate charges into the ambient conditioning zone may be achieved, for example, by corresponding, intermittent operation of a solid particle conveying medium, such as a conveyor belt, delivering the charges to (e.g., dropping them through), a hopper that is aligned with (e.g., above) the opening in the ambient conditioning zone. FIG. 16 illustrates an embodiment in which the loading step (a) is repeated, following a prior cycle of steps (a) to (d), with optional substeps (c1) and (c2) and/or (d1) and (d2). In this case, solid particle conveying medium 303, which may have remained stationary during steps (b) to (d) of the prior cycle, is operated again in step (a) of the following cycle to introduce an additional charge of solid particles 301 through loading hopper 300 and opening 305, aligned with ambient conditioning zone 325. This following cycle then proceeds to step (b), after accumulation in the solids transmission conduit, of the full feedstock charge, having been delivered with the discontinuous operation of solid particle conveying medium 303, according to step (a) of this following cycle.

FIGS. 7 and 17 illustrate additional features relating to apparatuses as described herein, and methods for their operation.

With reference to these figures, but with the understanding that not all features shown are required, particular embodiments of the invention are directed to: an apparatus for transferring solid particles, with such apparatus comprising a telescoping ram according to any of the embodiments described herein, together with solids transmission conduit 302 having ambient conditioning zone 325, between a front end and a back end of this conduit, for loading the solid particles. The primary ram and the secondary ram are extendible (e.g., together) through the ambient conditioning zone, and the secondary ram is further extendible from (e.g., independently of) the primary ram, through the front end of the solids transmission conduit. When the primary ram and the secondary ram are in an at least partially retracted position (e.g., fully retracted position, with respect to the primary pressure shell and/or solids transmission conduit), opening 305 is formed for loading the solid particles through this opening (e.g., through the top of) ambient conditioning zone 325. The apparatus may further comprise a hopper that is aligned with, such as positioned above, the opening of the ambient conditioning zone.

Regarding various options for loading of solid particles, such as performed according to a repeated, feedstock loading cycle, considerations include the average size (e.g., according to their diameter or otherwise their longest dimension) of these solid particles, which may generally be significantly smaller, relative to that of the front ends or bases of the primary and secondary rams that contact them in effecting their transfer. The solid particles may be free-flowing, or may tend to bridge or agglomerate. They may have various geometries, including spherical, fibrous, or irregularly-shaped, and they may likewise vary considerably in terms of their piece density and average bulk density, the latter characteristic depending, for example, on whether the solid particles pack tightly or in a manner that can be considered as “fluffy.” Advantageously, the motion of the primary and secondary rams, in combination with the solids transmission conduit, can transfer a wide range of particles into environments of various processes (e.g., gasification, pyrolysis, or hydropyrolysis), having a wide range of conditions. According to a particular method for transferring particles, they may be (possibly among other steps) (1) dropped into a loading channel, (2) pushed into the ambient conditioning zone, (3) sealed in the isolation zone with a live seal ring having little or no susceptibility to abrasion, and (4) further pushed (e.g., in the same direction) to outside of the solids transmission conduit, and into the process environment, after preparation to remove air from the isolation zone. This particular method can prevent undesired particle bridging, and can also avoid the need to compress the particles to form a plug. A hopper, used to guide the solid particles into the ambient conditioning zone, may have given geometry (e.g., expanding in an upward direction away from the solids transmission conduit, or expanding in a downward direction toward this conduit), depending on the composition of the feedstock and other characteristics, such as the propensity of the solid particles to agglomerate.

The apparatus may be configured for removing air from the ambient conditioning zone, such as by being supplied with purge gas to this zone, for displacing the initial environment of the solid particles. With respect to options for increasing cycle speed/loading capacity, as well as pre-purging of solid particles, considerations include their ability to fall freely into the solids transmission conduit, which may have an opening that forms a “trough” at the bottom of the loading hopper. The descent of the solid particles can facilitate the displacement of air, if desired. For example, a “long-drop” hopper, or hopper with other suitable geometry (e.g., to establish a desired solid particle residence time) may be favorable in this regard, optionally with purging from below by an ambient conditioning zone purge gas, such as a stream of dense inert gas (e.g., cold CO₂).

With the use of purging, some or most of the air initially present with the solid particles may be removed by the time these particles are loaded into the ambient conditioning zone of the solids transmission conduit. Remaining air may then be displaced during the phase of the loading cycle characterized by the primary ram being at least partially retracted and forming the opening in the ambient conditioning zone. The use of vacuum on, or purging of, the environment of the ambient conditioning zone may be avoided in some embodiments. In some cases, compression of the environment of the solid particles, upon subsequent ram movement, can “push” remaining air and/or ambient conditioning zone purge gas, out of this environment (e.g., of the isolation zone), prior to subsequent transfer of the charge through the valve (e.g., flapper valve, gate valve, or ball valve) at an end of the solids transmission conduit and into a process environment (e.g., surge vessel used in this environment). If the delay associated with transitioning the environment of the isolation zone (e.g., needed for vacuum and purging with either inert gas or gas that is characteristic of process environment) can be eliminated, then the loading cycle can be expedited. For example, the use of only vacuum and/or process gas may reduce or eliminate inert gas consumption. Pre-purging of the solid particles and/or shortening of their dwell time in the ambient conditioning zone can further reduce cycle time, although gas consumption may be increased to attain a desired degree of inertization and/or environment transition.

As described above, the apparatus may further comprise a live seal ring surrounding the primary ram (e.g., proximate its front end), which can be activated or deactivated (e.g., pressurized or depressurized) to isolate a first environment of an ambient conditioning zone from a second environment of a process and/or from an intermediate environment of an isolation zone. Optionally in conjunction with such live seal ring, the apparatus may further comprise a valve at the front end of the solids transmission conduit. When closed, this valve isolates or seals the second environment of the process from the first environment of the ambient conditioning zone, as well as optionally from an intermediate environment of the isolation zone. As in the case of changing the environment of the ambient conditioning zone (e.g., by purging), the apparatus may be configured for changing an environment of an isolation zone, formed between the front end of the secondary ram and the valve, for example by removing air from the isolation zone. More generally, the environment of this zone may be changed, not only in terms of its composition, but also in terms of its pressure, as described above. The environment of the isolation zone may be considered as having been transitioned, insofar as conditions (e.g., gas composition and pressure) are changed to more closely approximate those of the process.

Regarding additional possibilities, prior to displacing the primary and secondary rams through the ambient conditioning zone, a cover plate may be used (e.g., sent forward) to cover this zone and thereby address any tendency for the solid particles to “ride up” and out of the ambient conditioning zone, when the primary ram is extended. Extending of the rams under this plate may promote more efficient transfer(s) of the solid particles into the isolation zone and/or further to outside of the solids transmission conduit. Components and tolerances involved in construction of the ambient conditioning zone and its opening, the solids transmission conduit, and/or the isolation zone, do not necessarily require precision machining. Components may be formed, for example, from low-precision conventional ASTM/ASME pipe hardware, with sufficient clearance to avoid jamming of the primary and secondary rams during their motions. The ambient conditioning zone, the solids transmission conduit, and/or the isolation zone can have a round cross-section (e.g., as in the case of the primary and/or secondary rams), or can have various possible other cross-sectional shapes, such as polygonal (e.g., square or rectangular), with the main consideration being that the walls do not interfere with the motion of the primary and secondary rams. To hinder particle dust and dirt from fouling fluids within the rams, the primary and/or secondary rams may include exterior shells, such as to contain hydraulic actuation fluid that may be disposed, for example, in an inner assembly, within such exterior shell.

In comparison with conventional lock hoppers used for transferring solid particles, telescoping rams as described herein exhibit improvements along a number of lines, both operationally and in their construction. In using lock hoppers, it is often not possible to determine whether this device has been properly emptied, without the need for expensive and specialized instrumentation. In contrast, telescoping rams described herein can provide verified and controlled positioning of both the primary and secondary rams, such as in the case of utilizing position sensors at appropriate points (e.g., on the actuation tube extending to the back base of the primary ram, and/or on the indexing rod extending through a dedicated fitting, through the actuation tube, and to the back base of the secondary ram). Telescoping rams described herein furthermore offer greater flexibility in terms of controlling the speed with which particles (e.g., feedstock) enter the ambient conditioning zone, as well as the speed with which these are transferred to the environment of the process (e.g., a surge vessel of the process).

Overall, aspects of the invention relate to telescoping rams, apparatuses for their application in the transfer of solid particles, and processes that integrate these devices and apparatuses for the conversion of such solid particles to higher-value products. The telescoping rams offer a number of advantages over a broad range of operations, in terms of their high volumetric capacity, reduced energy and material consumption, and simplicity of construction and implementation, all of which contribute to lowering capital and operating costs. Those having skill in the art, with the knowledge gained from the present disclosure, will recognize that various changes can be made to the disclosed telescoping rams, apparatuses, and processes, without departing from the scope of the present disclosure. As such, it should be understood that the features of the disclosure are susceptible to modifications and/or substitutions without departing from the scope of the inventive aspects. The specific embodiments illustrated and described herein are for illustrative purposes only, and not limiting of the invention as set forth in the appended claims.

### EXAMPLE

The following example is set forth to represent a specific embodiment of the present invention, without limiting its scope in view of the present disclosure and as defined by the appended claims.

To illustrate volumetric capacity and efficiency of a representative telescoping ram, a case study was conducted to evaluate a facility for converting 1000 metric tons per day (MTPD), based on moisture- and ash-free weight, of loose woody biomass feedstock particles in the form of sawdust. The loose bulk density of the solid particles of sawdust was about 0.4 kg/L, and their moisture and ash contents were assumed to be about 10 wt-% and about 0.5 wt-%, respectively. In this case, therefore, about 1100 MTPD of the solid particles is required, corresponding to about 2750 cubic meters (m³) per day of the loose feedstock. In view of the ability to compress this material to about 0.6 kg/L in the isolation zone of the solids transmission conduit, the processing of about 1800 compressed m³/day is required. Assuming this zone has a bore and length of 408 mm and 1.5 meters, respectively, its volume is estimated at 0.2 m³. With a telescoping ram feeder having the ability to cycle every 15 seconds, its volumetric processing capacity is 1130 m³/day, such that two feeders with a combined 2260 m³/day of capacity would easily satisfy the processing requirement.

1. A telescoping ram, comprising:
a primary ram and a secondary ram, said secondary ram being at least partly disposed within the primary ram;
wherein the primary ram and secondary ram are configured for displacement, responsive to pressure applied in a primary pressure shell; and
wherein the secondary ram is configured for independent displacement with respect to the primary ram, responsive to pressure applied in a secondary pressure shell.

2. The telescoping ram of claim 1, wherein at least a portion of the secondary pressure cell protrudes from outside of the primary pressure cell to within the primary pressure cell.

3. The telescoping ram of claim 2, wherein said portion of the secondary pressure cell is an actuation tube forming a sliding seal with the primary pressure cell.

4. The telescoping ram of claim 1 or claim 2, wherein a back base interior surface of the primary pressure cell defines a fully retracted position of the primary ram, and contact between a primary ram stop and a back base exterior surface of the primary pressure cell defines a fully extended position of the primary ram.

5. The telescoping ram of claim 4, wherein the primary ram stop is disposed on an exterior surface of the secondary pressure shell.

6. The telescoping ram of any one of claims 1 to 5, wherein an indexing rod protrudes from outside of the secondary pressure cell to within the secondary pressure cell.

7. The telescoping ram of any one of claims 1 to 4, wherein a back base interior surface of the primary ram defines a fully retracted position of the secondary ram, and contact between a secondary ram stop and back base exterior surface of the secondary pressure cell defines a fully extended position of the secondary ram.

8. The telescoping ram of claim 7, wherein the secondary ram stop is disposed on the indexing rod.

9. The telescoping ram of any one of claims 1 to 8, further including:
a primary pressure port for introduction primary pressurization fluid to, and/or removal of primary pressurization fluid from, the primary pressure cell, and/or
a secondary pressure port for introduction secondary pressurization fluid to, and/or removal of secondary pressurization fluid from, the secondary pressure cell.

10. The telescoping ram of any of the preceding claims, which is a two-stage telescoping ram, and optionally wherein the primary ram and secondary ram are the only rams of the telescoping ram.

11. A method of transferring solid particles, the method comprising:
displacing the primary ram and the secondary ram of the telescoping ram of any one of the preceding claims,
wherein said displacing causes the transferring of the solid particles from a first environment into a second environment.

12. A method for transferring solid particles, the method comprising:
(a) with a primary ram and a secondary ram of a telescoping ram being in an at least partially retracted position that forms an opening in an ambient conditioning zone of a solids transmission conduit, loading the solid particles into the ambient conditioning zone;
(b) displacing the primary ram from the at least partially retracted position to an at least partially extended position, causing movement of a front end of the secondary ram through the ambient conditioning zone and the transferring of the solid particles.

13. The method of claim 12, wherein step (b) further comprises displacing the secondary ram with respect to the primary ram to cause the transferring of the solid particles.

14. The method of claim 12 or claim 13, wherein, in step (b), said movement of the front end of the secondary ram through the ambient conditioning zone causes an initial transfer of the solid particles from the ambient conditioning zone to an isolation zone within the solids transmission conduit and isolated from the ambient conditioning zone.

15. The method of claim 14, wherein the isolation zone is isolated from the ambient conditioning zone by said movement of the front end of the secondary ram through the ambient conditioning zone, in combination with pressurization of a live seal ring at an axial position between the ambient conditioning zone and the isolation zone.

16. The method of claim 14 or claim 15, further comprising changing an environment of the isolation zone.

17. The method of claim 16, wherein changing the environment of the isolation zone comprises removing air.

18. The method of claim 16 or claim 17, wherein changing the environment of the isolation zone comprises purging the environment with inert gas or process gas.

19. The method of any one of claims 14 to 18, further comprising:
(c) displacing the secondary ram from an at least partially retracted position to an at least partially extended position, causing movement of a front end of the secondary ram, and the transferring of the solid particles, to outside of the solids transmission conduit.

20. The method of claim 19, wherein step (c) comprises:
(c1) displacing the secondary ram from the at least partially retracted position to an intermediate extended position with respect to the primary ram, and optionally,
(c2) further displacing the secondary ram to the at least partially extended position with respect to the primary ram,
wherein said intermediate position is more fully extended with respect to the primary ram, compared to said at least partially retracted position, and wherein said at least partially extended position is more fully extended with respect to the primary ram, compared to said intermediate position.

21. The method of claim 19 or claim 20, wherein displacing the secondary ram to the at least partially extended position causes the opening of a valve at an end of the solids transmission conduit, wherein said valve, when closed, isolates the second environment of the process from first environment of the ambient conditioning zone, and also from an intermediate environment of the isolation zone.

22. The method of claim 21, wherein the valve is a flapper valve, a gate valve, or a ball valve.

23. The method of claim 21 or claim 22, wherein the valve is actuated.

24. The method of any one of claims 19 to 23, further comprising:
(d) displacing the secondary ram, causing movement of the front end of the secondary ram, from outside of, to within, the solids transmission conduit.

25. The method of claim 24, wherein step (d) comprises displacing the secondary ram to the at least partially retracted position with respect to the primary ram that forms an opening in an ambient conditioning zone of a solids transmission conduit.

26. The method of claim 24 or claim 25, wherein step (d) causes the closing of a valve at an end of the solids transmission conduit.

27. The method of any one of claims 24 to 26, wherein step (d) comprises:
(d1) displacing the secondary ram from the at least partially extended position to an intermediate retracted position with respect to the primary ram, and
(d2) further displacing the secondary ram to the at least partially retracted position with respect to the primary ram that forms an opening in an ambient conditioning zone of a solids transmission conduit.

28. The method of claim 27, further comprising, following step (d1) and prior to step (d2) deactivating a live seal ring surrounding the primary ram, proximate its front end.

29. The method of any one of claims 12 to 28, wherein, during step (a) of loading the solid particles into the ambient conditioning zone, removing air from the ambient conditioning zone.

30. The method of any one of claims 12 to 29, wherein step (a) is performed in conjunction with operating a solid particle conveying medium to introduce the solid particles into a hopper that is aligned with the opening in the ambient conditioning zone.

31. The method of any one of claims 24 to 30, wherein steps (a) to (d) are performed repeatedly to cause transferring of separate loadings of the solid particles from the first environment of the ambient conditioning zone to the second environment of the process.

32. The method of claim 31, wherein repeated steps (a) are performed in conjunction with intermittent introductions of the separate loadings into the ambient conditioning zone, through a hopper that is aligned with the opening in the ambient conditioning zone.

33. An apparatus for transferring solid particles, the apparatus comprising:
the telescoping ram of any one of claims 1 to 9, and
a solids transmission conduit having an ambient conditioning zone, between a back end and a front end, for loading the solid particles;
wherein the primary ram and the secondary ram are extendible through the ambient conditioning zone, and the secondary ram is extendible through the front end, and
wherein, when the primary ram and the secondary ram of the telescoping ram are in an at least partially retracted position an opening is formed for loading the solid particles into the ambient conditioning zone.

34. The apparatus of claim 33, wherein the apparatus is configured for removing air from the ambient conditioning zone.

35. The apparatus of claim 33 or claim 34, further comprising a live seal ring surrounding the primary ram, which can be activated to isolate a first environment of an ambient conditioning zone from a second environment of a process and/or from an intermediate environment of an isolation zone.

36. The apparatus of any one of claims 33 to 35, further comprising a valve at the front end of the solids transmission conduit, wherein said valve, when closed isolates the second environment of the process from the first environment of the ambient conditioning zone.

37. The method of claim 36, wherein the valve is a flapper valve, a gate valve, or a ball valve.

38. The method of claim 36 or claim 37, wherein the valve is actuated.

39. The apparatus of any one of claims 36 to 38, wherein the apparatus is configured for changing an environment of an isolation zone, formed between the front end of the secondary ram and the valve, by removing air from the isolation zone.

40. The apparatus of any one of claims 36 to 39, wherein the apparatus is configured for changing an environment of an isolation zone, formed between the front end of the secondary ram and the valve, by purging the isolation zone with inert gas or process gas.

41. The apparatus of any one of claims 33 to 40, further comprising a hopper that is aligned with the opening in the ambient conditioning zone.
